(19) United States
(12) Patent Application Publication
(10) Pub. No.: US 2007/0054027 A1
(43) Pub. Date: Mar. 8, 2007

(54) Starch hydrolysis products for size enlargement

(76) Inventors: Eric Weisser, Somerset, NJ (US); James J. Kasica, Whitehouse Station, NJ (US); Monika K. Okoniewska, Princeton, NJ (US)

Correspondence Address: NATIONAL STARCH AND CHEMICAL COMPANY, P.O. BOX 6500, BRIDGEWATER, NJ, 08807-3300, US

(21) Appl. No.: 11/222,088

(22) Filed: Sep. 8, 2005

(51) Int. Cl. A23D 9/00

(52) U.S. Cl. 426/601

(57) ABSTRACT

This invention relates to a composition of starch and an active material which will function to form a tablet when subjected to compression forces. The advantages of this invention are ease of use and handling, improved storage and pot life, and low reducing sugars. These starch binder materials will find application in areas such as pharmaceuticals, detergents and agricultural products and are characterized by their rheological properties.

### FIELD OF INVENTION

This invention relates to the use of hydrolyzed starches as a binder for size enlargement processing such as wet granulation and/or agglomeration and the resultant compositions.

### SUMMARY OF THE INVENTION

This invention relates to the use of hydrolyzed starches as binders for size enlargement processes such as wet granulation and/or agglomeration, and the resultant compositions. Such a composition comprises an active material and a starch binder, wherein said starch binder comprises a hydrolyzed starch having a viscosity of less than 10 Pa·s at 1 s⁻¹ shear rate and a tan delta of greater than 1 at 10 rad/s using the tests detailed in the Examples section.

As used herein, tablet is intended to mean a solid form composed of a plurality of particles compressed together.

### DETAILED DESCRIPTION OF THE INVENTION

Base starches or flours (together hereinafter “starches”) for use in this invention may be derived from any plant source such as cereals, tubers, roots, legumes, seeds and fruits. The native source can be corn, pea, potato, sweet potato, banana, barley, wheat, rice, sago, amaranth, tapioca, arrowroot, oat, canna, sorghum, and waxy or high amylose varieties thereof. As used herein, the term “waxy” is intended to include a starch containing at least about 95% amylopectin by weight of the starch and the term “high amylose” is intended to include a starch containing at least about 40%, particularly at least about 70%, more particularly at least about 80% amylose by weight of the starch.

Starches of this invention are further processed to reduce the viscosity of the native base by hydrolysis (conversion). This can be accomplished by hydrolytic action of acid and/or heat; oxidized starches prepared by treatment with oxidants such as sodium hypochlorite or hydrogen peroxide; and fluidity or thin boiling starches prepared by enzyme conversion or mild acid hydrolysis; physical degradation such as shear; or a combination of any of the above. A requirement for any of these materials is a reducing sugars (RS) content of less than 5% using the test detailed in the Examples section. In one embodiment, the reducing sugars content is less than about 2%.

Optionally the base materials can be chemically modified to prevent retrogradation or to add other desired functionality. The modification may be accomplished by reaction with etherification or esterification reagents known in the art. Non-limiting examples of such reagents are alkylene oxides, such as ethylene oxide or propylene oxide, acetic anhydrides including adipic acetic anhydrides, succinic anhydrides and derivatized succinic anhydrides, such as octenylsuccinic anhydride and dodecenylsuccinic anhydride. In one embodiment, the reagent is an alkylene oxide and in another embodiment is propylene oxide.

The base materials may be stabilized by treatment with oxidizing reagents. Examples of suitable oxidizing agents include, but are not limited to, hydrogen peroxide, sodium and calcium hypochlorite, and sodium hypobromide.

Chemically modified and oxidized starches, and methods for making them, are described in “Starch: Chemistry and Technology”, edited by R. L. Whistler et al, Chapter X, 1984.

One skilled in the art will realize that the order of modification and conversion may often be done in any order and sometimes simultaneously. One skilled in the art would realize the limitations of this combination. For example, oxidation can be used to both reduce the viscosity (molecular weight) and stabilize the base material at the same time. Conversely, if an ester is chosen as the stabilizing group, an acid conversion to reduce molecular weight must be accomplished prior to esterification in order not to hydrolyze the labile ester groups.

The materials embodied in this invention may be granular or pregelatinized. The term “granular starch” is intended to mean any starch which retains at least part of its granular structure thereby exhibiting some crystallinity, so that the granules are birefringent and the Maltese cross is evident under polarized light. Pregelatinized starches are those starches, which have been treated to destroy the granular structure and will now swell or disperse in cold water (cold water soluble—CWS). When used as a granular product, the materials must be cooked prior to use in the application by any means known in the art, such as bath cooking, or direct or indirect steam cooking.

When used as a solution, the binder solution viscosity will depend upon the level of conversion and the application solids. In one embodiment, the viscosity is less than 10 Pa·s, and in another less than 0.35 Pa·s, at a shear rate of 1 s⁻¹ at room temperature (25° C.) and 30% solids. In a further embodiment, the viscosity is less than 1 Pa·s, and in still another less than 0.02 Pa·s, at a shear rate of 1 s⁻¹ at room temperature (25° C.) and 15% solids.

One requirement of the binder solution is that the material not retrograde through molecular associations (hydrogen bonding) at room temperature, i.e. form a gel. For the purposes of this application, retrogradation is defined and measured as having a rheological value for tan delta at 10 rad/s of less than, or equal to 1 at the desired application solids and room temperature (a tan delta greater than 1 does not retrograde and is acceptable). In one embodiment, the base material will be modified with propylene oxide to provide resistance against retrogradation.

In another embodiment of this invention, the binder solution, at 15% solids, will exhibit viscosity stability for 24 hours. For purposes of this application, viscosity stability is defined as a change of less than 20% when the starch solution (at a minimum of 10% solids) is held at 25° C. (room temperature) for 24 hours. In one embodiment, the viscosity stability at such conditions is less than 10% and in another embodiment, less than 5%.

The resultant starches are useful as a binder for particle size enlargement of any active material. Examples of active materials include, but are not limited to; detergents, vitamins, flavors, neutraceuticals and nutritional supplements, food type materials such as bouillon cubes and confections, pharmaceuticals such as drugs and pain killers, dyes, release agents, herbicides, pesticides, and herbal extracts. Non-functional ingredients may also be added into the binder system to assist in processing and redispersibility. Examples of non-functional ingredients include, but are not limited to, fillers, colors, dispersants, and sugars.

The binder may be used in wet granulation or agglomeration of the active material using processes known in the art. The binder is used in an amount sufficient to create the desired particle size and strength such that they can be used in tableting applications. In one embodiment, the binder is used to prevent excess dusting and in another to improve the flowability of the active material. In one embodiment, the binder is used in an amount of from about 1% to about 10% by weight of the end use composition. In another embodiment, the binder system consists essentially of the hydrolyzed starch of this invention.

The following examples are offered to further illustrate the utility of this invention and are not meant to limit the scope in any way. All percentages are as dry weight basis unless otherwise noted.

### EXAMPLES

Materials

The following materials are used in the examples:

SAMPLE 1: MALTRIN® M150 commercially available from Grain Processing Corporation (Muscatine, Iowa), (13-17DE).

SAMPLE 2: Drum dried corn starch commercially available from National Starch and Chemical (Bridgewater, N.J.) as NATIONAL 78-1551.

SAMPLE 3: Native waxy maize starch commercially available from National Starch and Chemical (Bridgewater, N.J.) as AMIOCA® starch.

SAMPLE 4: A granular waxy maize starch converted to a water fluidity of 78.5 WF.

SAMPLE 5: High amylose maize starch containing 70% amylose commercially available from National Starch and Chemical (Bridgewater, N.J.) as HYLON® VII starch.

SAMPLE 6: A granular tapioca starch was converted to a water fluidity of 84 WF.

SAMPLE 7: A CWS waxy maize starch converted to water fluidity of 35 WF and treated with 8.5% propylene oxide. The converted and stabilized granular material was then processed according to the methods of U.S. Pat. Nos. 4,600,472, 4,610,760 and 5,149,799 and agglomerated.

SAMPLE 8: A CWS waxy maize starch enzyme converted to a viscosity of 0.18-0.25 Pa·s at 15% solids, a shear rate of 10 s⁻¹ and room temperature using beta-amylase and dried.

SAMPLE 9: A granular waxy maize starch converted to a water fluidity of 66 WF and treated with acetic anhydrate to yield a bound acetyl level of 1.6%.

SAMPLE 10: A CWS waxy maize starch converted to a viscosity of 0.02-0.03 Pa·s at 15% solids, a shear rate of 10 s⁻¹ at room temperature and treated with 3% octenyl succinic anhydride. The starch is made cold water soluble by steam cooking then drying.

SAMPLE 11: A CWS waxy maize starch treated with 8.5% propylene oxide then converted under acidic conditions in a steam cooking process to a viscosity of between 0.038-0.056 Pa·s (19% solids, at a shear rate of 10 s⁻¹ at room temperature) then dried.

SAMPLE 12: A white corn dextrin having a 400 cps borated viscosity with a minimum of 97% solubility.

SAMPLE 13: A canary potato dextrin having a 800 cps borated viscosity with a minimum of 90% solubility.

SAMPLE 14: A solution stable tapioca dextrin having a 80000 cps borated viscosity with a solubility of 100%.

SAMPLE 15: A canary waxy maize dextrin having a 800 cps borated viscosity with a solubility of 100%.

I. Starch Solution Preparation

a. Jet cooking (JC): Granular starches that were jet cooked were slurried in polished water at 17% solids (anhydrous). The slurry was jet-cooked using a mini-jet cooker at 149° C. and 414 kPa back pressure with 60% steam flow. After jet cooking, the starch solution was collected and diluted with hot water to the desired solids concentration. High amylose starch solutions samples were placed into a preheated thermos prior to dilution to prevent retrogradation.

b. Bath-Cooking (HWD): Granular starches that were bath cooked were slurried at the appropriate solids concentration (anhydrous) in a 100 ml beaker. Before the beaker was placed into the bath, it was weighed and the total weight recorded. The sample then was placed into a hot water bath (95-100° C.) and cooked, while stirring for the first 5 minutes for a total of 20 minutes. After cooking, the beaker was weighed again and water added to adjust for the loss during cooking.

c. Cold Water Dispersion (CWD): The required starch and water were weighed separately to make up the desired weight concentration. The starch powder was added to the beaker containing the water into the vortex resulting from a rotating magnetic stirrer and was mixed until the starch had completely dispersed, typically around 20 minutes.

II. Granulation Procedure

Dicalcuim phosphate (DCP) and microcrystalline cellulose (MCC) were weighed and mixed together for 10 minutes in a V-type mixer. Batch size was standardized at 500 g. Binder solutions were prepared by one of the three methods described above. The binder solutions were cooled to room temperature prior to use in the formula, except jet cooked binder solutions were used hot. The formula used is shown in Table 1 below:

TABLE 1
Granulation Formulation Used To Prepare The Examples

| Ingredient | % w/w |
|---|---|
| Dicalcium phosphate (Spectrum, Lot OS0311) | 85.7 |
| Avicel ® PH 102 NF (MCC) (FMC lot #2813) | 9.5 |
| Starch (Binder) | 4.8 |
| | (dry) |

The appropriate amount of binder solution was subsequently added to the blend to make up the desired binder concentration in the formula and mixed in a Hobart mixer until granulation was complete. The granulation end-point was detected visually when all the binder solution was well mixed into the powder and the powder formed loose agglomerates.

After the granulation procedure, the material was forced through an 1800-μm screen and the wet granules were dried in a hot-air oven at 65° C. for approximately 24 hours until the residual moisture in the granules was less than 4% w/w. The dry granules were sieved through an oscillating granulator (841 micrometer mesh size) and stored in tightly capped polypropylene bottles until tableted.

III. Tableting Procedure

The powder blends were compressed with a 12.5 mm punch and corresponding die on a 10-station rotating press. A station was tooled to compress 600 mg of powder at 17.2 MPa, 24.1 MPa, and 41.4 MPa compression pressure.

IV. Tablet Strength

Crushing strengths were determined (n=5) using a Pharmatron (Model 6D tablet tester, Dr. Schleuniger co., NH).

V. Conversion Viscosity Measurements and Dextrin Solubility

a. Viscosity—Water Fluidity (WF)

Water fluidity (WF) is an empirical measure of viscosity on a scale of 0-90, wherein fluidity is the reciprocal of viscosity. Water fluidity of starches is typically measured using a Thomas Rotational Shear-type Viscometer (commercially available from Arthur A. Thomas Co., Philadelphia, Pa.), standardized at 30° C., with a standard oil having a viscosity of 24.73 cps, which oil requires 23.12.+/−0.05 sec for 100 revolutions. Accurate and reproducible measurements of water fluidity are obtained by determining the time which elapses for 100 revolutions at different solids levels depending on the starch's degree of conversion, see Table 2, as conversion increases, the WF viscosity value decreases.

TABLE 2
Solids Level for WF determination

| Sample | WF Range |
|---|---|
| 7 gram | 8-32 |
| 10 gram | 32-50 |
| 13 gram | 50-62 |
| 15 gram | 62-up |

b. ABF and Solubility Procedure for Dextrins
Viscosity is measured as borated viscosity using a Brookfield viscometer. An enamel cup and thermometer are tared (tare weight). 66.6 grams of anhydrous sample are weighed into the cup. DI water is added and the sample is mixed well to uniformly wet-out and form a paste. Additional water is added to bring the starch mixture weight to 200 grams. The mixture is then placed in a boiling-water-bath and brought to 90° C. with constant stirring and held at 90° C. for five minutes. The mixture is next placed in an ice bath and cooled to 70° C. with constant stirring. 9.99 grams of borax are then added and the sample is stirred for five minutes while maintaining temperature at 70° C. The mixture is then placed in an ice bath and cooled to 25° C. with constant stirring. The mixture is brought back to weight by replacing lost moisture with DI water. The viscosity is then taken using a Brookfield model DV-11+ viscometer (commercially available from Brookfield) at 25° C., 20 rpm and using an appropriate spindle.
VI. Water Solubility
Water solubility is determined by taking two grams of anhydrous sample are wetted out in a small beaker, quantitatively transferred to a 200 mL volumetric flask, and diluted to approximately 1 mL of the 200 mL mark with ambient temperature DI water. The flask is stoppered and mixed by inverting the flask for two minutes. The flask is placed in a 22.2±0.4° C. environment for four hours. At the end of the four hours, the sample is diluted to the 200 mL mark and is mixed by inverting for an additional two minutes. The contents are filtered through Whatman Number 1 or equivalent filter paper. A 50 mL aliquot of the filtrate is pipetted into previously dried, tared 100 mL beakers filled one-third with a pure laboratory grade of sand and evaporated to dryness overnight in a 105° C. oven. The beakers are then removed and placed in a zero percent relative humidity desiccator and allowed to cool. The beakers are then removed from the desiccator and weighed immediately on an appropriate analytical balance. The solubility is calculated as follow, running each sample in duplicate and averaging the results.
Solubility(% in water)=Weight of residue×100/Weight of sample(dry basis)
VII. Rheology Procedures

Dynamic mechanical and steady viscosity tests on the starch solutions/dispersions were carried out on a Rheometrics Fluids Spectrometer II and a Rheometrics Fluids Spectrometer III (obtained from Rheometrics Scientific, Piscataway, N.J.). Measurements were made using a couette geometry in all cases.

Starch dispersions were prepared as described above. After the starch was thoroughly dispersed and cooled to room temperature, it was loaded onto the rheometer, controlled to 22-25° C., and rheological testing was begun immediately.

The testing procedure utilized is based on standard techniques in the art and is described by in detail by C. W. Macosko (Rheology Principles, Measurement and Applications, Chapter 1, 2 & 5, VCH, NY, 1994).

a. Steady-State Viscosity

To measure the steady shear viscosity, a sample was placed in the couette rheometer cell. The rate sweep was performed from 0.1 to 100 s⁻¹ with 5 points per decade of shear-rate. Each value of shear-rate was applied for 60 seconds, with no torque reading taken during the initial 30 seconds. By the end of this period, any time effects that were likely to occur had been reduced to levels that would not influence the viscosity measurement. Torque readings obtained during the final 30 seconds at each shear rate were converted to viscosity values, based on the geometry of the fixture used and the torsion constant of the instrument.

Viscosity values at a shear rate of 1, 10 and 100 s⁻¹ are taken as indicative of the material behavior. A ‘shear thinning’ index, n′, can be determined for the change in viscosity over the 1 to 100 s⁻¹ range, as follows:
n′=1+slope
where the slope is the log change in viscosity divided by the log change in shear rate across the shear rate region of interest.

b. Oscillatory Shear Measurements

i. Strain Sweep: The first measurement was an oscillatory shear strain sweep, performed at a frequency (ω) of 1 rad/s. The strain sweep extended from a strain (γ) of γ=0.1% to γ=100%. From this test, the maximum strain in the linear viscoelastic window of the sample is determined (γₗᵥ). The linear viscoelastic strain is defined as a strain that is small enough that it does not disrupt the structure of the material being measured.

ii. Frequency sweep: The second test completed on the starch dispersion is an oscillatory shear frequency sweep, performed at a strain (γ) less than the maximum linear viscoelastic strain determined from the strain sweep (γₗᵥ). In the frequency sweep test, the frequency was varied from 0.1 rad/s to 100 rad/s in five equally spaced (log spacing) increments per decade of frequency. From the frequency sweep test, the storage modulus (G′) and the loss modulus (G″) as well as the tangent to the phase angle, tan δ, can be determined. These values at certain frequencies are reported as characteristic properties of the binder solution. For the purpose of these experiments, the predisposition to gelling is taken at a single frequency (10 rad/s). Materials displaying the characteristics of a rheological gel can be described as having a tan δ that is close to 1 and independent of frequency across the measurement window being investigated, and that values of tan δ below 1 are characteristic of a elastic dominated or gelled material, while value of tan δ above 1 are characteristic of a viscous dominated material.

VIII. Reducing Sugars

The Reducing Sugars test was performed by Fehling's method based on the test described in Food Chemicals Codex, 4^{th} ed., Jul. 1, 1996, section 5, General Tests and Assays, Appendix X: Carbohydrates (Starches, Sugars and Related substances) and is as follows.

Disperse starch at 5% in DI water. Filter or centrifuge as required to remove particulate matter to use as the titre solution. 5 ml of each Fehling solutions, A and B (Solution A: Dissolve 34.6 grams of pure crystallized copper sulfate (CuSO4.5H20) with distilled water. Using volumetric flask, bring up to 500 cc. Solution B: Dissolve 173 grams of Rochelle salt (NaKC4H4O6.4H2O) and 50 grams of sodium hydroxide with distilled water. Using a volumetric flask, bring up to 500 cc) were added to 50 ml of DI water in Erlenmeyer flask. The mixture was brought to boiling point and boiled for 2 minutes and then titrated with the sample solution until the end point was reached as determined by appearance of a distinctive reddish color. The end point was verified by addition of methylene blue (1 gram methylene blue in 100 cc distilled water). The volume of sample solution (SV) required to reach the end point was recorded. The percent reducing sugars (RS) was calculated using Fehling factor (FF) and concentration of sample solution (SC) according to the formula RS=(FF×100)/(SV×SC). The Fehling Factor is obtained each time new Fehling solutions are prepared by titration of the Fehling solutions A and B against standardized dextrose.

### Example 1

### Utility of Starch as a Binder

In this example, various starch compositions were evaluated as wet granulation binders. Samples were evaluated at the concentration at which they would be used in the granulation as illustrated in Table 3 (based on viscosity and stability). Temperature is room temperature, unless otherwise noted.

TABLE 3
Binding Properties of Various Starches

| | | | Hardness (N) at |
|---|---|---|---|
| Sample # | Solids (%) | Prep. Method | 24.1 MPa |
| 1 | 30 | CWD | 66.6 |
| 2 (starch control) | 10 | HWD | 36.3 |
| 3 | 20 | JC | 46.1 |
| 4 | 27 | JC | 60.8 |
| 5* | 25 | JC | 42.1 |
| 11 | 30 | CWD | 63.7 |
| 12 | 30 | CWD | 40.2 |
| 13 | 30 | CWD | 40.2 |
| 14 | 30 | CWD | 42.1 |

*Added into the granulation at greater than 60° C.

This example indicates that a wide range of starch bases and molecular weights may function as a binder; however, the ability to be easily handled and used in a commercial operation is constrained by processing requirements such as pumpability and pot stability as illustrated in subsequent examples.

### Example 2

### Room Temperature Viscosity at Application Solids

This example illustrates the range of chemical and physical modifications that can be applied to starch to provide the viscosity required to overcome the limitations of the current starch paste materials (Sample 2), i.e., high (unstable) viscosity at room temperature and low solids (˜10%).

The starch samples were dispersed as indicated in Table 4 and allowed to cool to room temperature. The viscosity (steady shear) was determined as described above.

TABLE 4
Room Temperature viscosity of Various Starches
at 15% and 30% Solids

| | | Viscosity (Pa · s) at 1 s⁻¹ | |
|---|---|---|---|
| Sample # | Prep method | 15% solids | 30% solids |
| 2* (starch control) | HWB | 151.0 | |
| 3 | JC | 3.33 | |
| 7 | HWB | 1.00 | 10.00 |
| 8 | HWB | 0.19 | 5.33 |
| 9 | HWB | 0.16 | 2.74 |
| 10 | HWB | 0.03 | 0.75 |
| 4 | HWB | 0.03 | 0.63 |
| 11 | CWS | 0.02 | 0.32 |
| 6 | HWB | 0.02 | 0.48 |
| 14 | HWB | 0.008 | 0.02 |
| 15 | HWB | 0.004 | 0.02 |

*Measured at 10% solids

The above table shows all the starches with a viscosity at a shear rate of 1 s⁻¹ of less than 10 Pa·s and at 30% solids and 1 Pas at 15% solids are considerably lower in viscosity than the 10% solids starch paste of sample 2. With the viscosity criteria defined above, the starches of this invention will demonstrate enhanced ability to be pumped and handled at higher solids. A higher solid will translate to reducing the amount of water which has to be removed during the drying process.

### Example 3

### Room Temperature Elasticity at Application Solids

This example shows that as well as meeting a viscosity criteria as described in Example 2, the materials of interest should not form a rheological gel at room temperature. The starch samples were dispersed as indicated in Table 5 and allowed to cool to room temperature. The elasticity (tan δ) and modulus (oscillatory shear measurements) were determined as described above.

TABLE 5
Elasticity of Various Starches.

| | | Preparation | |
|---|---|---|---|
| Sample # | Solids (%) | Method | tan δ @ 10 rad/s |
| 2 (starch control) | 10 | HWB | 0.38 |
| 3 | 15 | JC | 1.76 |
| 7 | 15 | HWB | 4.19 |
| 11 | 15 | CWB | 12.00 |
| 7 | 30 | HWB | 2.46 |
| 11 | 30 | CWB | 52.85 |
| 4 | 30 | HWB | 94.82 |

Table 5 shows examples of starches which do not gel at room temperature (i.e. tan δ is greater than 1 at 10 rad/s), unlike the starch paste of Sample 2. Samples that gel offer significant problems in processing and sample stability during use. To describe starch pastes that gel at room temperature, the rheological characteristic of tan δ of greater than or equal to about 1 at a frequency of 10 rad/s, at a minimum of 10% solids is used. One skilled in the art will know that increasing starch concentration will increase the predisposition to gel, thus lowering the tan δ, such that materials which gel at 10% will also gel at 15% and 30% starch solids. Also, starches high in amylose will tend to form gels more readily than amylopectin containing starches.

### Example 4

### Viscosity Stability Over Time

Example 4 shows the effect of time on stability of a sample stored at room temperature. All samples were cooked at 15% solids using the methods described above, as listed in Table 5, and cooled to room temperature. The steady shear viscosity was measured directly after cooling and then after storage for 24 hours (steady shear viscosity at 1 s⁻¹, room temperature). Table 6 shows the percent change (final viscosity minus initial viscosity divided by the final viscosity) of each of the samples.

TABLE 6
24 Hour Viscosity Stability

| Sample # | Preparation Method | % Change |
|---|---|---|
| 6 | HWB | 295% |
| 7 | HWB | 39.6% |
| 9 | HWB | 30.0% |
| 8 | HWB | 18.1% |
| 4 | JC | 5.7% |
| 15 | HWB | 5.5% |
| 10 | HWB | <5% |
| 11 | CWD | <5% |
| 14 | HWB | <5% |

The samples numbered 4, 8, 10, 11, 14, and 15 corresponding to the highly converted waxy maize starches, Samples 4, 10 and 11 (with no stabilization, with octenyl succinic anhydride stabilization, and with propylene oxide stabilization, respectively) and Samples 14, and 15 (the canary waxy corn and solution stable tapioca dextrins, respectively), represent materials considered to have acceptable viscosity stability for typical use. Viscosity changes of greater than 20 percent are undesirable.

### Example 5

### Low Reducing Sugars

The compositions of this invention are lower in reducing sugars than the maltodexrin control (Sample 1).

TABLE 7
Reducing Sugars

| Sample | Reducing Sugars (%) |
|---|---|
| 14 | 0.50% |
| 11 | 1.80% |
| Sample 1 (maltodextrin control) | >5.0% |

We claim:

1) A tablet comprising an active material and a binder, wherein said binder comprises a starch having a steady shear viscosity of less than 10 Pa·s at a shear rate of 1 s⁻¹ shear rate and a tan delta of greater than 1 at 10 rad/s, at 25° C. and 30% solids.

2) The tablet of claim 1, wherein the starch has a steady shear viscosity of less than 0.35 Pa·s at a shear rate of 1 s⁻¹ shear rate and a tan delta of greater than 1 at 10 rad/s, at 25° C. and 30% solids.

3) The tablet of claim 1, wherein the starch has a steady shear viscosity at 15% solids of less than 1 Pa·s at a shear rate of 1 s⁻¹ shear rate and a tan delta of greater than 1 at 10 rad/s at 30% solids, at 25° C.

4) The tablet of claim 1, wherein the starch has a steady shear viscosity at 15% solids of less than 0.02 Pa·s at a shear rate of 1 s⁻¹ shear rate and a tan delta of greater than 1 at 10 rad/s at 30% solids, at 25° C.

5) The tablet of claim 1, wherein the starch has a reducing sugars content of less than about 5%.

6) The tablet of claim 1, wherein the starch has a reducing sugars content of less than about 2%.

7) The tablet of claim 1, wherein the starch is a chemically modified starch.

8) The tablet of claim 1, wherein the starch is modified with an alkylene oxide.

9) The tablet of claim 1, wherein the starch is modified with propylene oxide.

10) The tablet of claim 1, wherein the starch is pregelatinized.

11) The tablet of claim 1, wherein the starch is viscosity stable.

12) The tablet of claim 11, wherein the starch at 15% solids, has a viscosity which changes less than 20% over 24 hours at 25° C.

13) The tablet of claim 11, wherein the starch at 15% solids, has a viscosity which changes less than 10% over 24 hours at 25° C.

14) The tablet of claim 11, wherein the starch at 15% solids, has a viscosity which changes less than 5% over 24 hours at 25° C.

15) The tablet of claim 1, wherein the binder consists essentially of the starch.

16) The tablet of claim 1, wherein the starch comprises from 1 to 10% by weight of the tablet.

17) A process for size enlargement of particles comprising;
dissolving a binder in water, wherein said binder comprises a starch having a steady shear viscosity of less than 10 Pa·s at a shear rate of 1 s⁻¹ shear rate and a tan delta of greater than 1 at 10 rad/s, at 25° C. and 30% solids,
mixing the binder with an active material and,
compressing the mixture into a tablet.

18) The process of claim 17, wherein the starch has a reducing sugars content of less than about 5%.

19) The process of claim 17, wherein the starch is a chemically modified starch.

20) The process of claim 17, wherein the starch is modified using propylene oxide.

21) The process of claim 17, wherein the starch is pregelatinized.

22) The process of claim 17, further comprising cooking the starch.

23) The process of claim 17, wherein the starch is viscosity stable.

24) The process of claim 17, wherein the binder consists essentially of the starch.
